(19) United States
(12) Patent Application Publication
(10) Pub. No.: US 2026/0228298 A1
(43) Pub. Date: Aug. 6, 2026

(54) COEFFICIENT DATA GENERATION DEVICE

(71) Applicant: Fujitsu Limited, Kawasaki-shi (JP)

(72) Inventor: Yutaka TAMIYA, Yokohama (JP)

(73) Assignee: Fujitsu Limited, Kawasaki-shi (JP)

(21) Appl. No.: 19/439,958

(22) Filed: Jan. 5, 2026

(30) Foreign Application Priority Data
Feb. 6, 2025 (JP) 2025-018311

(51) Int. Cl. G06F 17/11; G06F 17/17

(52) U.S. Cl. CPC G06F 17/11; G06F 17/17

(57) ABSTRACT

A coefficient data generation device that executes calculation of a nonlinear function by a piecewise polynomial, the coefficient data generation device including a calculator configured to perform calculation of output values of respective segments of the nonlinear function based on an input value, and a generator configured to generate coefficient data used in the calculation of the nonlinear function based on the output values calculated by the calculator.

### CROSS-REFERENCE TO RELATED APPLICATION

This application is based upon and claims the benefit of priority of the prior Japanese Patent application No. 2025-18311, filed on Feb. 6, 2025, the entire contents of which are incorporated herein by reference.

### FIELD

The present embodiment relates to a coefficient data generation device.

### BACKGROUND

In high performance computing (HPC) applications and machine learning (ML) applications, floating-point computation of a nonlinear function

$$( exp ( x ) , \frac{1}{\sqrt{{x}^{′}}} tanh etc . ) \qquad [ Formula 1 ]$$

is involved, and acceleration of these computations using a re-configurable accelerator is in demand.

For example, related arts are disclosed in United States Laid-open Patent Publication No. 2021/0319289, Japanese Laid-open Patent Publication No. JP 2023-513129, United States Laid-open Patent Publication No. 2022/0129262, Japanese Laid-open Patent Publication No. JP 2008-234076, and United States Laid-open Patent Publication No. 2023/0206032.

### SUMMARY

According to an aspect of embodiment(s), a coefficient data generation device that executes calculation of a nonlinear function by a piecewise polynomial, the coefficient data generation device including a calculator configured to perform calculation of output values of respective segments of the nonlinear function based on an input value, and a generator configured to generate coefficient data used in the calculation of the nonlinear function based on the output values calculated by the calculator.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a connection relationship between processing elements (PEs) in a related example;

FIG. 2 is a diagram illustrating an operation mappable to PE in the related example;

FIG. 3 is a diagram illustrating an implementation example of a nonlinear function by a piecewise polynomial in the related example;

FIG. 4 is a block diagram schematically illustrating a configuration example of a re-configurable accelerator in the related example;

FIG. 5 is a block diagram schematically illustrating a configuration example of a re-configurable accelerator in the embodiment;

FIG. 6 is a diagram for illustrating nonlinear function calculation by Taylor expansion;

FIG. 7 is a diagram for illustrating an operation in a generator illustrated in FIG. 5;

FIG. 8 is a diagram for illustrating an operation in a controller illustrated in FIG. 5; and

FIG. 9 is a block diagram schematically illustrating a hardware configuration example of the coefficient data generation device in the embodiment.

### DESCRIPTION OF EMBODIMENTS

In a case where a value of a nonlinear function is calculated by polynomial approximation, a coefficient table for accommodating polynomial coefficients is employed.

In a re-configurable accelerator, there is a problem that it takes time to update a look-up table (LUT) memory containing a coefficient table.

### [A] Related Example

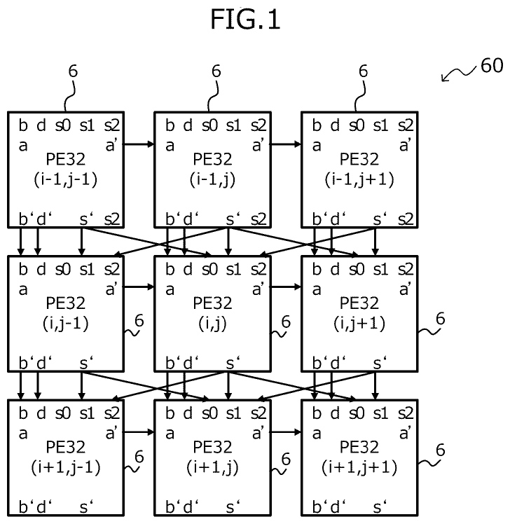

FIG. 1 is a block diagram illustrating a connection relationship between PEs 6 in a related example.

FIG. 1 illustrates a re-configurable accelerator 60, which is hardware that enables its configuration to be changed during execution.

In FIG. 1, the re-configurable accelerator 60 is hardware in which a plurality of (nine in the example illustrated in FIG. 1) PEs 6 of, for example, 32 bits that calculate addition and multiplication with respect to an input and a constant are connected to each other and perform complicated calculation as a whole.

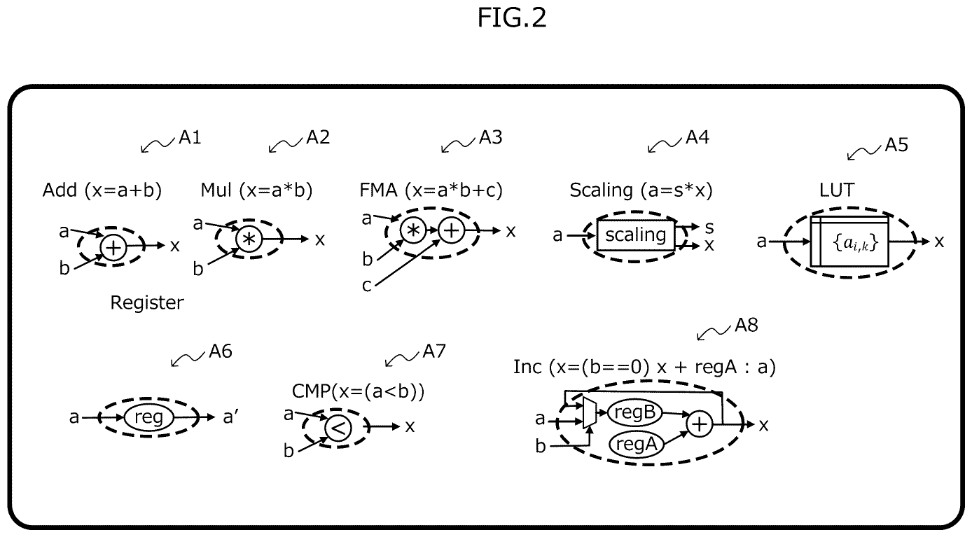

FIG. 2 is a diagram illustrating an operation mappable to the PE 6 in the related example.

The re-configurable accelerator 60 illustrated in FIG. 1 is capable of mapping the operations indicated by reference numerals A1 to A8 in FIG. 2 to the PE 6.

Add (x=a+b) indicated by reference numeral A1 represents two-operand floating-point addition, and it is also possible to fix an arbitrary input to a constant.

Mul (x=a*b) indicated by reference numeral A2 represents two-operand floating-point multiplication, and it is also possible to fix an arbitrary input to a constant.

FMA (x=a*b+c) indicated by reference numeral A3 represents addition and multiplication of a ternary floating point, and it is also possible to fix an arbitrary input to a constant.

Scaling (a=s*x) indicated by reference numeral A4 determines scaling s such that x falls within a specified range, and decomposes the expression as a=s*x.

LUT indicated by reference numeral A5 represents a Look-Up Table that performs a table lookup for a value corresponding to the input a.

Register indicated by reference numeral A6 holds an input value.

CMP (x=(a<b)) indicated by reference numeral A7 performs magnitude comparison, and outputs 1 in a case where the input a is smaller than the input b, and outputs 0 otherwise.

Inc (x=(b==0) x+regA: a) indicated by reference numeral A8 increases the output x by regA when b==0, and sets x to an initial value a when b≠0.

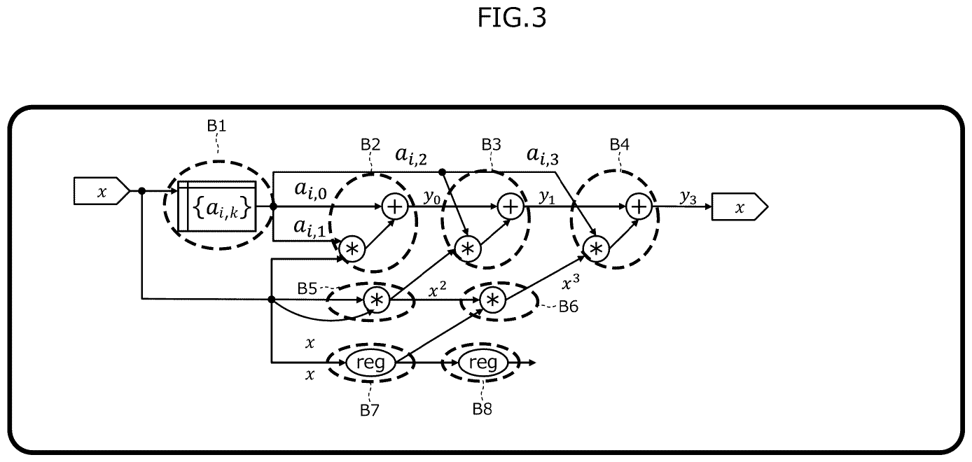

FIG. 3 is a diagram illustrating an implementation example of a nonlinear function by a piecewise polynomial in the related example.

The input x of the nonlinear function is divided into segments, and the calculation is performed for each segment using the following polynomial.

$$f ( z ) ≅ {{a}_{i , 3} ( x - {x}_{i} )}^{3} + {{a}_{i , 2} ( x - {x}_{i} )}^{2} + {a}_{i , 1} ( x - {x}_{i} ) + {a}_{i , 0} , \qquad [ Formula 2 ]$$

where {a_{i,k}} is a set of coefficients for interval xᵢ≤x≤xᵢ₊₁.

The LUT is used to store polynomial coefficients {a_{(i,k)}}. When a 256-segment single-precision (32-bit) cubic polynomial is used, the LUT capacity for the coefficients becomes 4 B*256*4=4 kB. As a result of mapping, as indicated by the dashed frames of reference numerals B1 to B8 in FIG. 3, eight PEs are used.

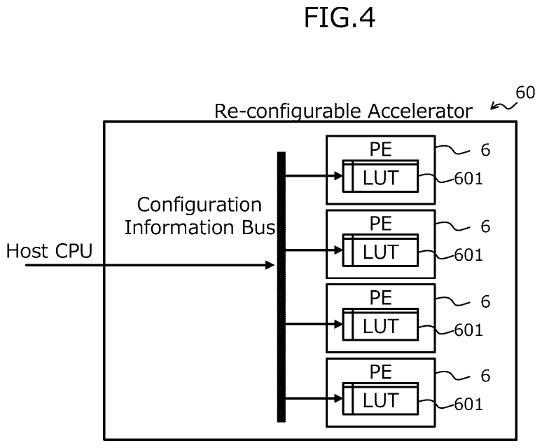

FIG. 4 is a block diagram schematically illustrating a configuration example of the re-configurable accelerator 60 in the related example.

As illustrated in FIG. 4, the re-configurable accelerator 60 includes the plurality of PEs 6 (four in the example illustrated in FIG. 4), which are connected to a host central processing unit (CPU) via a configuration information bus. Each PE 6 holds an LUT 601.

In the re-configurable accelerator 60, in a case where a nonlinear function is implemented by a piecewise polynomial, updating of the LUT 601 that stores coefficients becomes a problem.

Normally, data to be stored in each LUT 601 included in the respective PEs 6 is read from outside the accelerator 60 via the host CPU.

Since the data amount of the coefficient data is large and the host PC uses the bus, it takes a long time to update the LUT 601.

In “dynamic re-configuration”, in which the configuration of the accelerator 60 is changed during operation, when the update time of the LUT 601 is long, the period during which the accelerator 60 is not operating increases, which becomes a factor that degrades computational performance.

### [B] Embodiment

Hereinafter, an embodiment will be described with reference to the drawings. However, the embodiment described below is merely an example, and there is no intention to exclude the application of various modifications and techniques that are not explicitly described in the embodiment. That is, the present embodiment may be variously modified and implemented without departing from the gist thereof. Each drawing is not intended to include only the components illustrated in the drawing, but may include other functions and the like. Hereinafter, in the drawings, the same numerals denote the same parts, and thus the description thereof will be omitted.

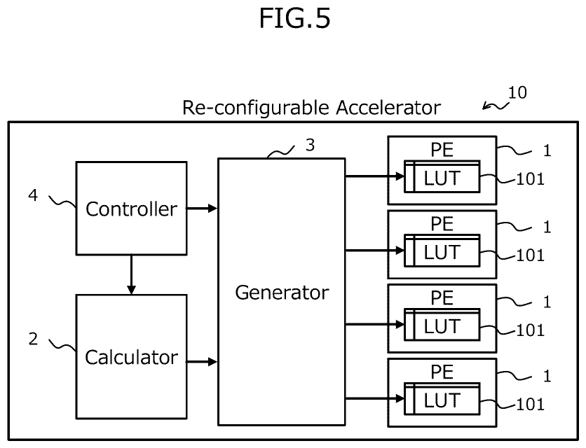

FIG. 5 is a block diagram schematically illustrating a configuration example of a re-configurable accelerator 10 in the embodiment.

The re-configurable accelerator 10 illustrated in FIG. 5 includes a plurality of (four in the example illustrated in FIG. 5) PEs 1, a calculator 2, a generator 3, and a controller 4. Each PE 1 holds an LUT 101. The calculator 2, the generator 3, and the controller 4 may be implemented using a re-configuration function of the accelerator 10.

The re-configurable accelerator 10 that uses the coefficient LUT 101 for calculation of a nonlinear function is the target.

The nonlinear function used during application operation is, similarly to the related example described above, calculated by a piecewise polynomial mapping onto a group of PEs 1 each having the LUT 101.

The calculator 2 calculates a function output value for each segment with respect to an input value, in order to generate coefficients.

The generator 3 generates coefficient data by storing, in the LUT 101, data based on the input values and output values generated by the calculator 2.

The controller 4 continuously controls the calculator 2 and the generator 3 to generate data for all entries in the LUT 101.

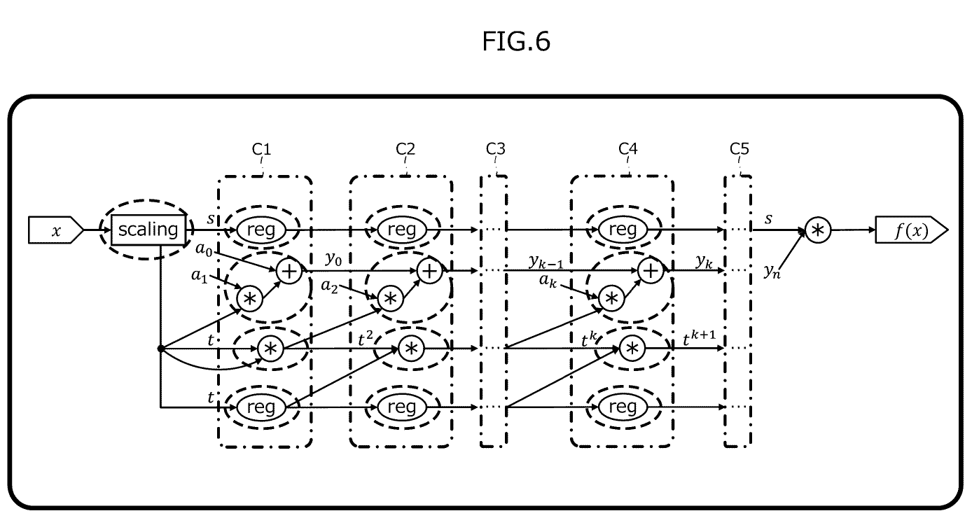

FIG. 6 is a diagram for illustrating nonlinear function calculation by Taylor expansion.

The calculator 2 calculates function output values by the Taylor expansion (or, in other words, a Maclaurin expansion) as shown in the following equation.

$$f ( x ) = {{\sum }_{k = 0}}^{n} \frac{{f}^{( k )} ( 0 )}{k !} {x}^{k} \qquad [ Formula 3 ]$$

For example, an exponential function exp(x) is expressed by the following polynomial.

$$exp ( x ) = 1 + x + \frac{{x}^{2}}{2 !} + \frac{{x}^{3}}{3 !} + … + \frac{{x}^{n}}{n !} \qquad [ Formula 4 ]$$

The number of terms needed varies depending on the type of nonlinear function and the calculation accuracy involved. In the case of exp(x), five terms are needed to obtain 32-bit precision, as indicated by the alternate long and short dash frames with reference numerals C1 to C5 in FIG. 6.

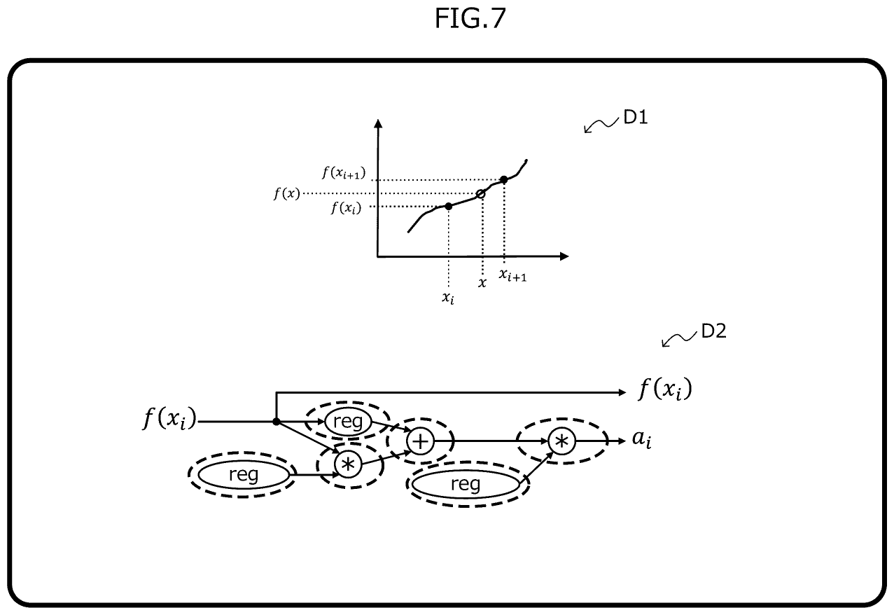

FIG. 7 is a diagram for illustrating an operation in the generator 3 illustrated in FIG. 5.

In the present embodiment, assuming that the calculator 2 provides a set {xᵢ, f(xᵢ)} of input values and nonlinear function output values for each equally spaced segment, an intermediate value is approximated by linear interpolation. Δx represents the length (constant) of each segment.

A graph indicated by reference numeral D1 in FIG. 7 is expressed by the following equation.

$$f ( x ) = {a}_{i} ( x - {x}_{i} ) + f ( {x}_{i} ) , where {a}_{i} = \frac{f ( {x}_{i + 1} ) - f ( {x}_{i} )}{Δ x} \qquad [ Formula 5 ]$$

The output of the generator 3 is {aᵢ, f(xᵢ)} for each segment.

The mapping of the generator 3 is represented by reference numeral D2 in FIG. 7 and is as follows.
(1) A value of f(xᵢ) for the previous segment is stored in a register (reg).
(2) Since 1/Δx needed for calculating aᵢ is pre-calculated as a constant by the CPU, it may be realized by multiplication in the accelerator 10.

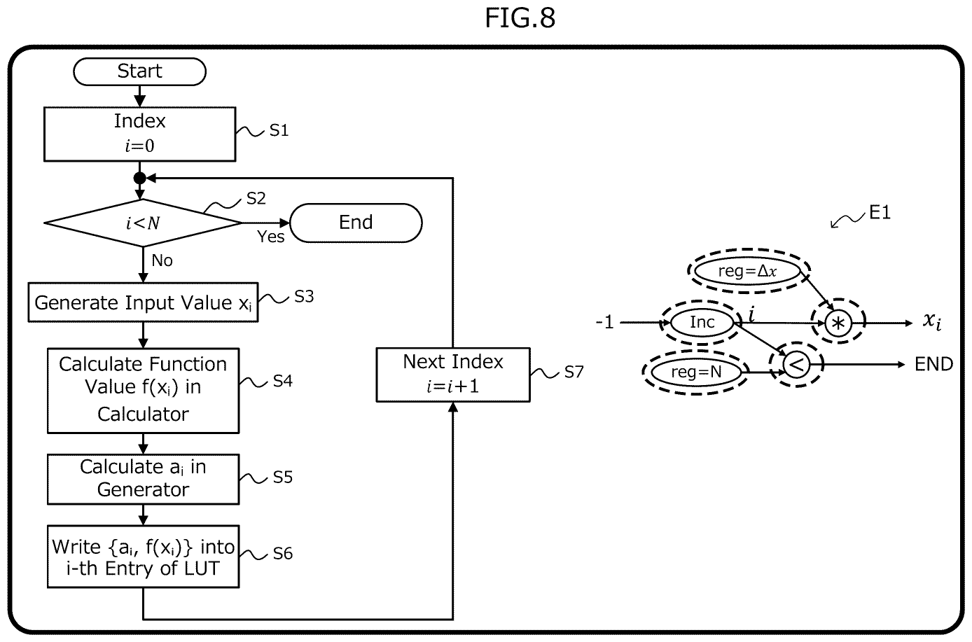

FIG. 8 is a diagram for illustrating an operation in the controller 4 illustrated in FIG. 5.

The controller 4 continuously controls the calculator 2 and the generator 3 to generate data for all entries in the LUT 101.

Control by the controller 4 writes, for example, coefficient data into the LUT 101 according to the flowchart shown in steps S1 to S7 of FIG. 8.

The mapping of the controller 4 is represented by reference numeral E1 in FIG. 8 and is as follows.

(1) i is increased from 0 to N by an Inc operation to generate xᵢ.

(2) During looping, END=1 is output, and after the loop ends, END=0 is output.

Hereinafter, the operation of the controller 4 in the embodiment will be described according to the flowchart (steps S1 to S7) illustrated in FIG. 8.

The controller 4 sets the index i=0 (step S1).

The controller 4 determines whether i<N (step S2).

In a case of i<N (see the Yes route of step S2), the process ends.

On the other hand, in a case of i≥N (see the No route of step S2), the controller 4 generates an input value xᵢ (step S3).

The controller 4 causes the calculator 2 to calculate a function value f(xᵢ) (step S4).

The controller 4 causes the generator 3 to calculate aᵢ (step S5).

The controller 4 writes {aᵢ, f(xᵢ)} into the i-th entry of the LUT 101 (step S6).

The controller 4 sets the next index i=i+1 (step S7), and the process returns to step S2.

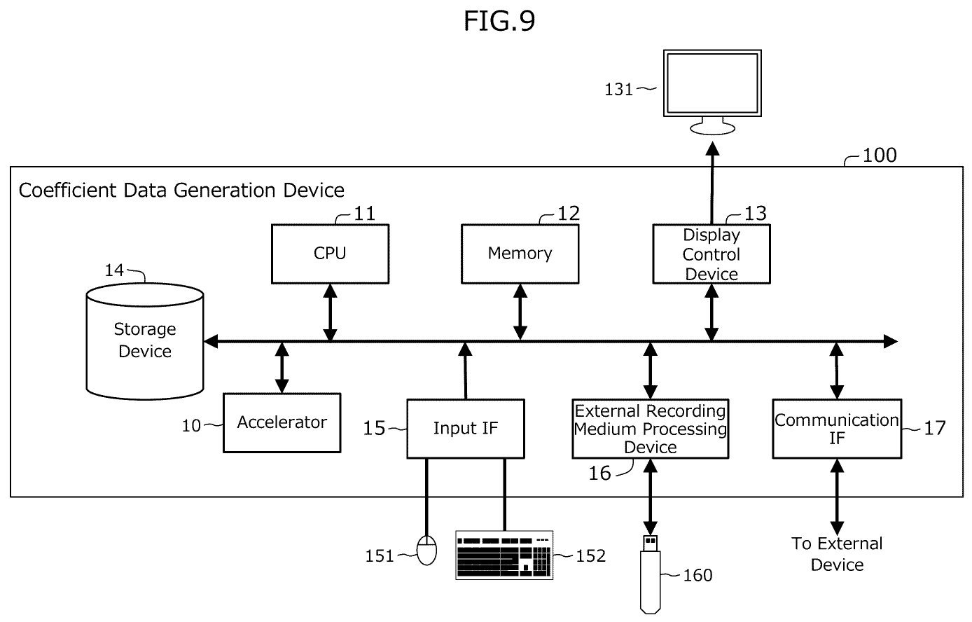

FIG. 9 is a block diagram schematically illustrating a hardware configuration example of a coefficient data generation device 100 in the embodiment.

The coefficient data generation device 100 may be, for example, a server, and, as illustrated in FIG. 9, includes the accelerator 10, a CPU 11, a memory 12, a display control device 13, a storage device 14, an input interface (IF) 15, an external recording medium processing device 16, and a communication IF 17.

As illustrated in FIG. 5, the accelerator 10 includes a plurality of PE 1 units, and functions as the calculator 2, the generator 3, and the controller 4. The accelerator 10 is reconfigurably configured.

The memory 12 is an example of a storage unit, and is, for example, a read only memory (ROM) or a random access memory (RAM). A program such as basic input/output system (BIOS) may be written into the ROM of the memory 12. A software program of the memory 12 may be appropriately read and executed by the CPU 11. In addition, the RAM of the memory 12 may be used as a temporary recording memory or a working memory.

The display control device 13 is connected to a display device 131 and controls the display device 131. The display device 131 is a liquid crystal display, an organic light-emitting diode (OLED) display, a cathode ray tube (CRT), an electronic paper display, or the like, and displays various types of information to an operator or the like of the coefficient data generation device 100. The display device 131 may be combined with an input device, and may be, for example, a touch panel. The display device 131 displays various types of information for a user of the coefficient data generation device 100.

The storage device 14 is a storage device having high IO performance, and for example, a dynamic random access memory (DRAM), a solid state drive (SSD), a storage class memory (SCM), or a hard disk drive (HDD) may be used.

The input IF 15 may be connected to an input device such as a mouse 151 or a keyboard 152 and control the input device such as the mouse 151 or the keyboard 152. The mouse 151 and the keyboard 152 are examples of the input devices, and the operator performs various input operations via these input devices.

The external recording medium processing device 16 is configured so that a recording medium 160 may be mounted. The external recording medium processing device 16 is configured to be able to read information recorded on the recording medium 160 in a state where the recording medium 160 is mounted. In this example, the recording medium 160 has portability. For example, the recording medium 160 is a non-transitory recording medium such as a flexible disk, an optical disk, a magnetic disk, a magneto-optical disk, or a semiconductor memory.

The communication IF 17 is an interface that enables communication with an external device.

The CPU 11 is an example of a processor, and is a processing device that performs various controls and calculations. The CPU 11 implements various functions by executing an operating system (OS) and a program read into the memory 12. Note that the CPU 11 may be a multiprocessor including a plurality of CPUs, a multi-core processor including a plurality of CPU cores, or a configuration including a plurality of multi-core processors.

The device for controlling the operation of the entire coefficient data generation device 100 is not limited to the CPU 11, and may be, for example, any one of an MPU, a DSP, an ASIC, a PLD, and an FPGA. Furthermore, the device for controlling the overall operation of the coefficient data generation device 100 may be a combination of two or more of the CPU, the MPU, the DSP, the ASIC, the PLD, and the FPGA. Note that the MPU is an abbreviation for micro processing unit, DSP is an abbreviation for digital signal processor, and ASIC is an abbreviation for application specific integrated circuit. In addition, PLD is an abbreviation for programmable logic device, and FPGA is an abbreviation for field programmable gate array.

### [C] Effects

According to the coefficient data generation device 100 of the embodiment described above, for example, the following operational effects may be achieved.

The calculator 2 performs calculation of output values of respective segments of a nonlinear function based on input values. The generator 3 generates coefficient data used for calculation of the nonlinear function based on the output values calculated by the calculator 2.

Accordingly, data may be updated inside the re-configurable accelerator 10, which reduces the time for loading data from the outside and enables acceleration of computation.

Specifically, since coefficient data in the LUT 101 is updated without using an external memory of the host CPU or the accelerator 10, no time is spent on data transfer. Furthermore, the generation time of the coefficient data can also be reduced because the calculation is performed using the arithmetic function of the accelerator 10, thereby achieving faster processing than calculation performed by the conventional CPU 11.

Even during application operation, a nonlinear function that becomes needed can be implemented in the accelerator 10. This mechanism allows flexible adaptation to dynamically constructed network models in machine learning applications.

The calculator 2 and the generator 3 are implemented in the re-configurable accelerator 10.

As a result, a wide variety of nonlinear functions may be implemented. Specifically, after the coefficient data is stored in the LUT 101, the calculator 2 and the generator 3 may be deleted, and another function may be implemented in the deleted PE 1 units, thereby accelerating the application.

The calculator 2 performs calculation of nonlinear functions using Taylor expansion.

Accordingly, by implementing the number of terms of the Taylor expansion as a fixed polynomial without loops, it may be implemented as a pipeline circuit, which improves the computational throughput speed of the accelerator 10.

The generator 3 generates coefficient data by linear interpolation.

This enables efficient generation of coefficient data.

### [D] Others

The disclosed technology is not limited to the above-described embodiments, and various modifications may be made without departing from the concept of the present embodiment. Each configuration and each process of the present embodiment may be selected or omitted as needed or may be appropriately combined.

In one aspect, the calculations in the re-configurable accelerator may be accelerated.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A coefficient data generation device that executes calculation of a nonlinear function by a piecewise polynomial, the device coefficient data generation comprising:
a calculator configured to perform calculation of output values of respective segments of the nonlinear function based on an input value; and
a generator configured to generate coefficient data used in the calculation of the nonlinear function based on the output values calculated by the calculator.

2. The coefficient data generation device according to claim 1, wherein the calculator and the generator are implemented in a re-configurable accelerator.

3. The coefficient data generation device according to claim 1, wherein the calculator performs calculation of the nonlinear function using a Taylor expansion.

4. The coefficient data generation device according to claim 2, wherein the calculator performs calculation of the nonlinear function using a Taylor expansion.

5. The coefficient data generation device according to claim 1, wherein the generator generates the coefficient data by linear interpolation.

6. The coefficient data generation device according to claim 2, wherein the generator generates the coefficient data by linear interpolation.
